(19) United States
(12) Patent Application Publication
(10) Pub. No.: US 2025/0239630 A1
(43) Pub. Date: Jul. 24, 2025

(54) POROUS MEMBRANES FOR FLOW BATTERIES AND BATTERIES INCLUDING SUCH MEMBRANES

(71) Applicant: Daramic, LLC, Charlotte, NC (US)

(72) Inventors: J. Kevin Whear, Utica, KY (US); Eric H. Miller, Philpot, KY (US); Andrew Goodby, Owensboro, KY (US); Margaret Roberts, Owensboro, KY (US); Daniel R. Alexander, Matthews, NC (US); Anna Verderame, Charlotte, NC (US)

(21) Appl. No.: 18/837,586

(22) PCT Filed: Feb. 7, 2023
(86) PCT No.: PCT/US2023/012496

§ 371 Date: Aug. 10, 2024

Related U.S. Application Data
(60) Provisional application No. 63/310,398, filed on Feb. 15, 2022.

(51) Int. Cl. H01M 8/0245; H01M 8/0239; H01M 8/18

(52) U.S. Cl. CPC H01M 8/0245; H01M 8/0239; H01M 8/188

(57) ABSTRACT

Disclosed herein is a composite membrane for a flow battery, having: a hydrophilic porous flat-sheet filled polyolefin membrane; and at least one other hydrophilic porous flat-sheet membrane. In other embodiments, an asymmetric hydrophilic porous flat-sheet membrane is disclosed. The asymmetric hydrophilic porous flat-sheet membrane may be an asymmetric hydrophilic porous filled polyolefin flat-sheet membrane.

### RELATED APPLICATION DATA

This application is a 371 U.S. Application which claims priority to PCT Application No. PCT/US2023/012496, filed Feb. 7, 2023, which claims priority to U.S. Provisional Application No. 63/310,398, which was filed on Feb. 15, 2022, and is incorporated herein in its entirety.

### FIELD

This application relates to flat-sheet porous membranes for use in flow batteries. Particularly, this application relates to flat-sheet filled polyolefin porous membranes for use in flow batteries.

### BACKGROUND

As concerns over climate change have risen, so has the need to find better sources of large-scale renewable energy. Because of its fast response to energy demand change, tolerance to deep discharge without fatal damage, and easy thermal management, and the ability to go from medium to large scale commercialization, the flow battery system has received some attention. A flow battery is an energy storage device that uses two soluble redox couples as electroactive materials via oxidation and reduction on opposite sides of a membrane. Flow batteries are also attractive as they can be rapidly recharged by replacing the liquid electrolyte while simultaneously recovering the spent material for recharging.

There are several types of flow batteries including the reduction-oxidation (redox) flow, membrane-less flow, organic flow, and hybrid flow. The redox flow battery (RFB) system is currently the most widely utilized Flow Battery. The RFB systems include Fe/Cr, Zn/Br₂ (ZBB), and polysulfide/Br₂ as well as vanadium RFB (VRFB). The chemical energy is provided by two distinct electrolytes comprising chemical components dissolved in liquids stored in tanks that are pumped through the system on separate sides of a membrane. Ions, along with an electric current, are exchanged across the membrane while both liquids circulate in their own respective tanks. The total amount of electricity, that can be generated, depends on the volume of electrolyte in the tanks. A charge and discharge occurs by utilizing the oxidation and reduction reactions of both the active substances; and the electrolyte solutions are circulated from storage tanks to an electrolytic bath, and a current is taken out and utilized. Many redox flow batteries include acidic electrolytes.

The membrane is one of the most important components in a redox flow battery. In redox flow cells, the function of the membrane is to prevent cross-contamination of the positive and negative electrolytes and the short circuiting of the two half-cell electrodes. It must also permit the transfer of ions to complete the circuit during the passage of current (e.g., H+ ions, Nations). Some identified characteristics of an ideal membrane include the following characteristics: good chemical stability under acidic conditions, resistance to a highly oxidizing environment of some positive half-cell electrolytes, low electrical resistance, high permeability/ionic conductivity to the charge carrying ions (e.g., hydrogen ions or sodium ions), low permeability to other non-charge-carrying electrolyte ions, good mechanical properties, and low cost. In addition to the above-mentioned characteristics, an important property that an ideal membrane must possess is the ability to prevent the preferential transfer of water from one half cell to the other, as this results in flooding of one half cell while diluting the other. Based on these many desired characteristics, the membrane has been identified as one of the main obstacles in the commercialization of many redox flow cells.

One of the biggest obstacles is providing a membrane that prevents cross-contamination of the two distinct electrolytes, while allowing charge-carrying ions to cross the membrane. An example of this is shown by looking at the vanadium redox flow battery. One of the most widely investigated membranes for these types of redox flow batteries have been those including perfluorosulfonic acid polymers such as DuPont's Nafion® membrane. Though this membrane has good stability in the highly oxidizing environment of vanadium flow batteries, it is lacking. Due to the higher cost and relatively poor selectivity of Nafion membranes for the vanadium ions, there exists a need to provide a membrane for commercial systems that can better meet this commercial need.

### SUMMARY

Flat-sheet porous membranes and composites that address some of the issues with current flow battery membranes are described herein. For example, the membranes and composites described herein may be better at preventing cross-contamination of the two distinct electrolytes used in a flow battery, while allowing transport of charge-carrying electrolyte ions across the membrane. The membranes may have good oxidation resistance, be stable in acidic environments, have low electrical resistance, have good mechanical strength, and be low cost.

In one aspect, a composite membrane for a flow battery is disclosed. The composite comprises: 1) a hydrophilic porous flat-sheet filled polyolefin membrane; and 2) at least one other hydrophilic porous flat-sheet membrane. In some embodiments, the at least one other hydrophilic porous flat-sheet membrane is also a hydrophilic porous flat-sheet filled polyolefin membrane.

In some embodiments, one of the hydrophilic porous flat-sheet membrane has a smaller average pore size than the other one. For example, the smaller average pore size may be less than 1 micron, less than 0.1 microns, less than 0.01 micron, or less than 0.001 micron. The smaller average pore size is small enough to greatly reduce cross-contamination of the electrolytes by reducing or minimizing the flow of any or all of the following ions: Vanadium (II) ions, Vanadium (III) ions, Vanadium (IV) ions, Vanadium (V) ions, bromide ions, polysulfide ions, Zinc (III) ions, Cerium (III) ions, and Cerium (IV) ions. These are ions found in some of the most common flow battery electrolytes. In some embodiments, the hydrophilic porous flat-sheet membrane having smaller average pore size is a calendered, a stretched, or a calendered and stretched porous flat-sheet membrane.

In some embodiments, the membrane having the smaller average pore size is also thicker than the other membrane. A thick tortuous membrane with smaller pores may even more effectively prevent the cross-contamination of electrolytes. The small pore size may block entry to the membrane, and the more tortuous path will slow the rate of diffusion of the ions across the membrane.

In other possible embodiments, at least one of the hydrophilic porous flat-sheet membranes of the composite comprises a surfactant therein or thereon. The surfactant may comprise one or more of an anionic surfactant, a non-ionic surfactant, an amphoteric surfactant, or combinations thereof. The surfactant may interact with electrolyte ions, and impede entry into and/or movement across the membrane. The interaction could be a chelate bonding, ionic bonding. Alternatively, the surfactant may form (e.g., by bringing oil or other additives to the surface) or act as a physical barrier on the surface of the membrane.

In other possible embodiments, at least one of the hydrophilic porous flat-sheet membranes of the composite comprises, therein or thereon, rubber, rubber-derivatives, latex, latex-derivatives, or combinations thereof.

In other possible embodiments, the hydrophilic porous flat-sheet filled polyolefin membrane of the composite comprises polyolefin, filler, and oil. The amount of oil is from 0.5% to 20%, 0.5% to 15%, 0.5% to 10%, 0.5% to 5%, 0.5% to 2%, or 0.5% to 1%.

In other possible embodiments, at least one of the hydrophilic porous flat-sheet membranes of the composite has an ER (10/20) of less than 250 mΩ-cm², less than 200 mΩ-cm², less than 150 mΩ-cm², less than 100 m²-cm², or less than 50 mΩ-cm².

In other possible embodiments, the composite has a thickness of 100 microns to 1,800 microns.

In some embodiments, at least one of the hydrophilic porous flat-sheet membranes of the composite comprises a coating that comprises a conductive material. The coating is preferably provided on an outward facing surface of the membrane. The conductive material may comprise carbon. An outward facing surface is one that is directly in contact with electrolyte.

In another aspect, an asymmetrical hydrophilic porous flat-sheet membrane for a flow battery is described in this application. In some embodiments, the membrane is a hydrophilic porous flat-sheet polyolefin filled membrane.

In some embodiments, the average pore size on one side of the membrane is smaller than the average pore size on the other side of the membrane. For example, the smaller average pore size may be less than 1 microns, less than 0.1 microns, less than 0.01 micron, or less than 0.001 micron. The smaller average pore size is small enough to greatly reduce or impede the flow of any or all of the following ions: Vanadium (II) ions, Vanadium (III) ions, Vanadium (IV) ions, Vanadium (V) ions, bromide ions, polysulfide ions, Zinc (III) ions, Cerium (III) ions, and Cerium (IV) ions. These are ions found in some of the most common flow battery electrolytes. In some embodiments, the membrane is calendered, supercalendered, or embossed using asymmetrical tooling to form the different average pore sizes. In some embodiments, the membrane is coated (e.g., an ionically or chemically grafted coating) on one side to form the different average pore sizes. Other methods for creating an asymmetrical membrane with different average pore size may include burnishing. In some embodiments, a non-woven membrane or mesh of polymer resins or resins derived from renewable materials such as polyethylene (PE) or bio-based PE may be laminated to one side of the membrane to create an asymmetrical membrane. In this different pore size embodiment, the asymmetrical membrane may also comprise a coating comprising a conductive material on at least one side thereof. The conductive material may comprise carbon.

In some embodiments, the asymmetrical membrane comprises a coating provided on one side of the membrane, and a different coating is provided on the other side. One of the coatings may be a surfactant coating. The surfactant may comprise a nonionic surfactant, an anionic surfactant, an amphoteric surfactant, or combinations thereof. In embodiments where the surfactant comprises a non-ionic surfactant, the membrane may comprise oil, latex, latex derivatives, rubber, rubber derivatives, or combinations thereof. In these surfactant-containing embodiments, the asymmetrical membrane may also comprise a coating comprising a conductive material on at least one side thereof. The conductive material may comprise carbon.

In some embodiments, the asymmetrical comprises latex, latex derivatives, rubber, rubber derivatives, or combinations thereof, and one side of the membrane has been cross-linked making it asymmetrical.

In other embodiments, the asymmetrical membrane comprises a coating that comprises a conductive material on at least one side thereof. The conductive material may comprise carbon.

### BRIEF DESCRIPTION OF THE DRAWINGS

FIG. 1 is a redox flow battery comprising a membrane (5) according to some embodiments described herein. The redox flow battery comprises an electrolyte bath (6), which comprises a positive electrode cell chamber (2) comprising a positive electrode (1). The redox flow battery also comprises a negative electrode cell chamber (4), which comprises a negative electrode 3. The membrane (5) separates the positive electrode cell chamber (2) from the negative electrode cell chamber (4). The positive electrode cell chamber (2) comprises a positive electrolyte solution. The negative electrode cell chamber (4) comprises a negative electrolyte solution. The positive electrode electrolyte solution and the negative electrode electrolyte solution comprising the active substances are, for example, stored in a positive electrode electrolyte solution tank (7) and a negative electrode electrolyte solution tank (8), and fed to respective cell chambers by pumps (10, 11) or the like. The membrane (5) in FIG. 1 is a composite membrane comprising two hydrophilic flat-sheet porous membranes as described herein where one of the membranes has a smaller average pore size and is thicker.

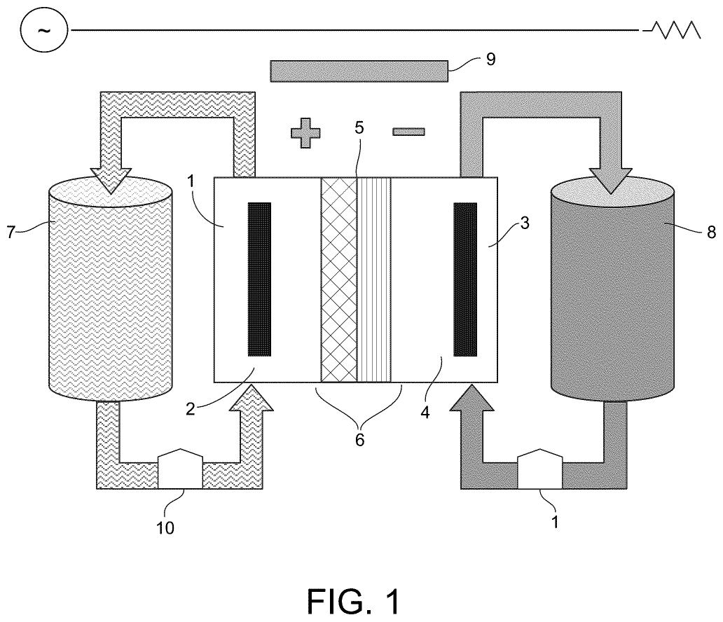

FIG. 2 is a flow battery comprising a membrane (5a) according to some embodiments described herein. The redox flow battery comprises an electrolyte bath (6), which comprises a positive electrode cell chamber (2) comprising a positive electrode (1). The redox flow battery also comprises a negative electrode cell chamber (4), which comprises a negative electrode 3. The membrane (5a) separates the positive electrode cell chamber (2) from the negative electrode cell chamber (4). The positive electrode cell chamber (2) comprises a positive electrolyte solution. The negative electrode cell chamber (4) comprises a negative electrolyte solution. The positive electrode electrolyte solution and the negative electrode electrolyte solution comprising the active substances are, for example, stored in a positive electrode electrolyte solution tank (7) and a negative electrode electrolyte solution tank (8), and fed to respective cell chambers by pumps (10, 11) or the like. In FIG. 2, the membrane 5a is a hydrophilic porous flat-sheet membrane as described herein with a carbon-containing layer (12) on both sides. The carbon can obviate the use of felts (e.g., carbon felts) typically used in redox flow batteries. When used, the felts are typically placed between the membrane and the electrodes.

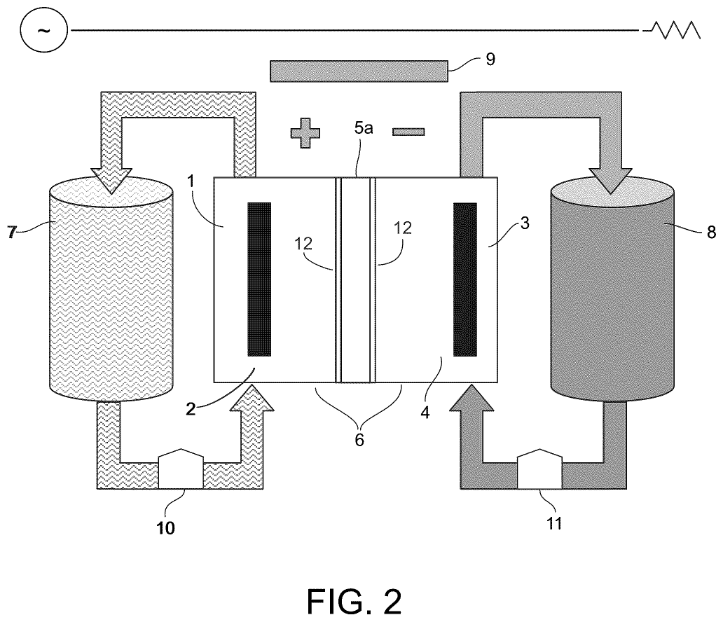

### DESCRIPTION

This application discloses hydrophilic porous flat-sheet membranes, and composites thereof, that can be use in flow batteries.

### Hydrophilic Porous Flat-Sheet Membranes

The term hydrophilic when used herein, refers to the fact that the membranes are wettable with acid, e.g., sulfuric acid or H₂SO₄ in water, having a concentration from 20-50%. Wettability may be measured according to BCIS-03B, January 2018, section 18, Wetting-Acid Flotation. A time less than 5 minutes is preferred.

The term flat-sheet when used herein means that the membrane surface is flat to the naked eye. However, in some embodiments, the membrane surface may have mini-protrusions or mini-ribs that may be seen by the naked eye. The ribs may have a height from 20 microns to 500 microns, to 400 microns, to 300 microns, to 200 microns, or to 100 microns. If added, the ribs may be continuous, discontinuous, for enhancing acid mixing, for improving compressibility, or the like. Additionally, because the ribs will typically have a different porosity than the remainder of the sheet, addition of ribs may create any pattern of different pore sizes on the surface. Further still, addition of ribs on one side of a sheet could result in an asymmetric membrane with different pore sizes on each surface.

The term porous may mean microporous, nanoporous, mesoporous, or macroporous. Mean pore size of the membrane may range from 0.0001 to 10 microns, 0.001 to 1 microns. 0.001 to 0.9 microns, 0.001 to 0.8 microns, 0.001 to 0.7 microns, 0.001 to 0.6 microns, 0.001 to 0.5 microns, 0.001 to 0.4 microns, 0.001 to 0.3 microns, 0.001 to 0.2 microns, 0.001 to 0.1 microns, 0.001 to 0.09 microns, 0.001 to 0.08 microns, 0.001 to 0.07 microns, 0.001 to 0.06 microns, 0.001 to 0.05 microns, 0.001 to 0.04 microns, 0.001 to 0.03 microns, 0.001 to 0.02 microns, 0.001 to 0.01 microns, 0.001 to 0.009 microns, 0.001 to 0.008 microns, 0.001 to 0.007 microns, 0.001 to 0.006 microns, 0.001 to 0.005 microns, 0.001 to 0.004 microns, 0.001 to 0.003 microns, or 0.001 to 0.002 microns. In preferred embodiments, the pores of the hydrophilic porous flat-sheet membranes described herein are tortuous, not through-holes. Tortuosity is commonly used to describe diffusion and fluid flow in a porous media. One indicator of tortuosity may be the Gurley of the membrane. The membranes described herein preferably have a Gurley (50 cc) greater than 200 seconds, greater than 300 seconds, greater than 400 seconds, greater than 500 seconds, greater than 600 seconds, greater than 700 seconds, greater than 800 seconds, greater than 900 seconds, greater than 1,000 seconds, greater than 1,100 seconds, greater than 1,200 seconds, greater than 1,300 seconds, greater than 1,400 seconds, greater than 1,400 seconds, greater than 1,500 seconds, greater than 1,600 seconds, greater than 1,700 seconds, greater than 1,800 seconds, greater than 1,900 seconds, greater than 2,000 seconds.

The thickness of the hydrophilic flat-sheet porous membranes described herein may range from 50 microns to 1,000 microns, from 100 microns to 950 microns, from 100 microns to 900 microns, from 100 microns to 850 microns, from 100 microns to 800 microns, from 100 microns to 750 microns, from 100 microns to 700 microns, from 100 microns to 650 microns, from 100 microns to 600 microns, from 100 microns to 550 microns, from 100 microns to 500 microns, from 100 microns to 450 microns, from 100 microns to 400 microns, from 100 microns to 350 microns, from 100 microns to 300 microns, from 100 microns to 250 microns, from 100 microns to 200 microns, or from 100 to 150 microns.

The material of the hydrophilic flat-sheet porous membranes (filled or unfilled) described herein are not so limited. For example, the hydrophilic flat-sheet porous membranes may comprise any thermoplastic polymer, including polyolefins, polycarbonate (PC), polysulfones, polyether ketone (PEK), polyetherether ketone (PEEK), polyamide, polystyrene (PS) polyvinylchloride (PVC), polyetherimide (PEI), or polytetrafluoroethylene.

In some preferred embodiments, the hydrophilic flat-sheet porous membrane described herein is a filled membrane made by mixing and then extruding a mixture comprising, consisting of, or consisting essentially of filler, thermoplastic polymer, and processing oil/plasticizer. The oil may extracted later to form pores. In some particularly preferred embodiments, the hydrophilic flat-sheet porous membrane is a polyolefin-filled membrane. A polyolefin-filled membrane as described herein may comprise, consist of, or consist essentially of a polyolefin, a filler, and a plasticizer or processing oil.

The polyolefin used is not so limited. Polyolefin, such as polypropylene, ethylene-butene copolymer, and preferably polyethylene may be used. In some more preferable embodiments, high molecular weight polyethylene, i.e. polyethylene having a molecular weight of at least 600,000, even more preferably ultrahigh molecular weight polyethylene, i.e. polyethylene having a molecular weight of at least 1,000,000, in particular more than 4,000,000, and most preferably 5,000,000 to 8,000,000 (measured by viscosimetry and calculated by Margolie's equation) are used.

The filler is not so limited. In some embodiments, the filler may comprise, consist of, or consist essentially of silica, talc, alumina, or combinations thereof.

The plasticizer or processing oil is not so limited. In some embodiments, the plasticizer or processing oil may include one or more of the following: petroleum oil, paraffin-based mineral oil, mineral oil, and any combinations thereof.

In certain selected embodiments, the membrane can be prepared by combining, by weight, about 5-15% polymer, in some instances, about 10% polymer, about 10-60% filler, in some instances, about 30% filler, and about 30-80% processing oil, in some instances, about 60% processing oil. In other embodiments, the filler content is reduced, and the oil content is higher, for instance, greater than about 61%, 62%, 63%, 64%, 65%, 66%, 67%, 68%, 69% or 70% by weight. The filler: polymer ratio (by weight) can be about (or can be between about these specific ranges) such as 2:1, 2.5:1, 3:1, 3.5:1, 4.0:1, 4.5:1, 5.0:1, 5.5:1 or 6:1. The filler: polymer ratio (by weight) can be from about 1.5:1 to about 6:1, in some instances, 2:1 to 6:1, from about 2:1 to 5:1, from about 2:1 to 4:1, and in some instances, from about 2:1 to about 3:1.

After extrusion, plasticizer or processing oil may be removed to form pores, but is not removed completely. Complete removal of the processing oil would result in increased electrical resistance (ER) of the membrane. In the final membrane product, oil content is preferably 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, or 1% or less. The oil content is greater than 0%.

In some embodiments, the membrane may comprise a surfactant therein or thereon. The surfactant may be one or more of a non-ionic surfactant, an ionic surfactant, or combinations of at least one non-ionic surfactant and at least one ionic surfactant.

The nonionic surfactant is not so limited and may be at least one selected from the following: fatty alcohols, cetyl alcohols, stearyl alcohols, pentaethylene glycol monododecyl ether, polyoxypropylene glycol alkyl ethers, polyoxyethylene glycol, octylphenol ethers, polyoxyethylene glycol alkyl ethers, octaethylene glycol monododecyl ether, polyoxyethylene glycol alkylphenol ethers, polyoxyethylene glycol sorbitan alkyl esters, Triton-X-100, oleyl alcohols, block copolymers of polyethylene glycol, block copolymers of polypropylene glycol, glucoside alkyl ethers, decyl glucoside, lauryl glucoside, octyl glucoside, nonoxynol-9, glycerol alkyl esters, polysorbates, sorbitan alkyl esters, glyceryl laurate, cocamide, costearyl alcohols, methallyl-capped non-ionic surfactant, polyol fatty acid esters, polyethyoxylated esters, polyethoxylated fatty alcohols, alkyl polysaccharides, alkyl polyglycosides, amine ethoxylates, sorbitan fatty acid ester ethoxylates, organosilicone based surfactants, ethylene vinyl acetate terpolymers, ethoxylated alkyl aryl phosphate esters, sucrose esters of fatty acids, polyethoxylated alcohols, polyethylene oxide, acid-soluble sugars, sucrose esters of fatty acids, organic fatty acids, hydroxyl acid, nonionic surfactant, octylphenol ethoxylate surfactant, octylphenol ethoxylate nonionic surfactant, and combinations thereof.

In some embodiments, the nonionic surfactant wherein the non-ionic surfactant has a cloud point rating greater than about 15° C., greater than about 20° C., or greater than about 25° C.

In some embodiments, the nonionic surfactant may have the following structures:

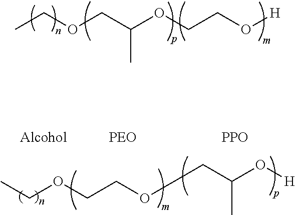

In the foregoing structures, n may be an integer from 5 to 20 or from 9 to 17, m may be an integer from 1 to 15 or from 6 to 10, and p may be an integer from 0 to 10 or from 0 to 7.

An amount of nonionic surfactant therein or thereon the membrane may be an amount of 0.1 to 10 g/m², 0.1 to 9 g/m², 0.1 to 8 g/m², 0.1 to 7 g/m², 0.1 to 6 g/m², 0.1 to 5 g/m², 0.1 to 4 g/m², 0.1 to 3 g/m², 0.1 to 2 g/m², 0.1 to 1 g/m², 0.1 to 0.9 g/m², 0.1 to 0.8 g/m², 0.1 to 0.7 g/m², 0.1 to 0.6 g/m², 0.1 to 0.5 g/m², 0.1 to 0.4 g/m², 0.1 to 0.3 g/m², or 0.1 to 0.2 g/m².

The ionic surfactant may be a cationic surfactant, an anionic surfactant, or an amphoteric surfactant.

In some embodiments, the ionic surfactant may be at least one selected from the following: sulfates; alkyl sulfates; ammonium lauryl sulfates; sodium lauryl sulfates; alkyl ether sulfates; sodium laureth sulfate; sulfonates, docusates; dioctyl sodium sulfosuccinate; alkyl benzene sulfonates; phosphates; alkyl ether phosphates; carboxylates; alkyl carboxylates; fatty acid salts; sodium stearate; sodium lauroyl sarcosinate; Alkyltrimethylammonium; cetylpyridinium; polyethoxylated tallow amine; benzalkonium; benzethonium; dimethyldioctadecylammonium; dioctadecyldimethylammonium salts of alkyl sulfates; alkylarylsulfonate salts; alkylphenol-alkylene oxide addition products; soaps; alkyl-naphthalene-sulfonate salts; one or more sulfo-succinates, such as an anionic sulfo-succinate; dialkyl esters of sulfo-succinate salts; amino compounds (primary, secondary or tertiary amines; quaternary amines; block copolymers of ethylene oxide and propylene oxide; various polyethylene oxides; salts of mono and dialkyl phosphate esters, and mixtures thereof.

In some embodiments, the ionic surfactant may be an anionic surfactant having the following structure:

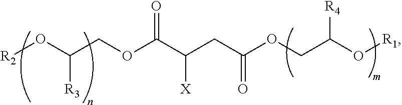

where n is an integer from 0 to 10, m is an integer from 0 to 10, R1 is H, a C1 to C10 linear or branched, saturated or unsaturated alkyl group, a C1 to C10 fatty alcohol, a C1 to C10 alcohol, or an aromatic group, and R2 is H, a C1 to C10 linear or branched, saturated or unsaturated alkyl group, a C1 to C10 linear or branched, saturated or unsaturated fatty alcohol, a C1 to C10 linear or branched, saturated or unsaturated alcohol, or an aromatic group, n and m are the same or different, R1 and R2 are the same or different, R3 is hydrogen or methyl, R4 is hydrogen or methyl, R3 and R4 are the same or different, X is a negatively charged groups such as SO3-, COO—, PO4-2, and the like. A positive counter ion to the anionic surfactant is also present and may be at least one of Na⁺, K⁺, Li⁺, NH₄⁺, Ca^{2+,}Mg²⁺, and the like.

In some embodiments, the ionic surfactant may be an anionic surfactant having the following formula:

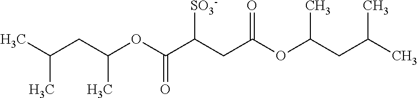

The amount of ionic surfactant may be an amount of 0.1 to 10 g/m², 0.1 to 9 g/m², 0.1 to 8 g/m², 0.1 to 7 g/m², 0.1 to 6 g/m², 0.1 to 5 g/m², 0.1 to 4 g/m², 0.1 to 3 g/m², 0.1 to 2 g/m², 0.1 to 1 g/m², 0.1 to 0.9 g/m², 0.1 to 0.8 g/m², 0.1 to 0.7 g/m², 0.1 to 0.6 g/m², 0.1 to 0.5 g/m², 0.1 to 0.4 g/m², 0.1 to 0.3 g/m², or 0.1 to 0.2 g/m2.

In some preferred embodiments, the membrane may comprise an anionic and a non-ionic surfactant provided thereon. In such embodiments, the total amount of surfactant may be an amount of 0.1 to 10 g/m², 0.1 to 9 g/m², 0.1 to 8 g/m², 0.1 to 7 g/m², 0.1 to 6 g/m², 0.1 to 5 g/m², 0.1 to 4 g/m², 0.1 to 3 g/m², 0.1 to 2 g/m², 0.1 to 1 g/m², 0.1 to 0.9 g/m², 0.1 to 0.8 g/m², 0.1 to 0.7 g/m², 0.1 to 0.6 g/m², 0.1 to 0.5 g/m2, 0.1 to 0.4 g/m², 0.1 to 0.3 g/m², or 0.1 to 0.2 g/m2.

In some preferred embodiments, the membrane may comprise natural or synthetic rubber, natural or synthetic rubber derivatives, natural or synthetic latex, natural or synthetic latex derivatives, or combinations of the foregoing. Amounts may range from 1 to 50%, from 1 to 40%, from 1 to 30%, from 1 to 20%, from 1 to 10%, or from 1 to 5%.

The rubber may be cross-linked rubber, un-cross-linked rubber, natural rubber, latex, synthetic rubber, and combinations thereof. The rubber may further be methyl rubber, polybutadiene, one or more chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber, silicone rubber, copolymer rubbers, and any combination thereof. The copolymer rubbers may be styrene/butadiene rubbers, acrylonitrile/butadiene rubbers, ethylene/propylene rubbers (EPM and EPDM), ethylene/vinyl acetate rubbers, and combinations thereof.

In some embodiments, the membrane may comprise a conductive material therein or thereon. In some preferred embodiments, the conductive material may comprise, consist of, or consist essentially of carbon. For example, the carbon may be one of conductive carbon, graphite, artificial graphite, activated carbon, acetylene black, carbon black, high surface area carbon black, graphene, high surface area graphene, ketjen black, carbon fibers, carbon filaments, carbon nanotubes, or any combinations thereof.

In some embodiments, the membranes described herein may be stretched, calendered, or stretched and calendered. These processes may be performed to affect the strength, pore size, or other properties of the membrane.

### Composite

The composites described herein comprise at least one of the membranes described hereinabove. In some embodiments, the composite may comprise, consist of, or consist essentially of one of the membranes described herein above and at least one other hydrophilic porous flat-sheet membrane. In some embodiments, the composites described herein may comprise, consist of, or consist essentially of at least two of the membranes described herein above. In other embodiments, the hydrophilic porous flat-sheet membrane may be a fibrous membrane comprising polymeric fibers, glass fibers, or a combination thereof.

The thickness of the composite may be from 100 microns to 1,800 microns, from 100 microns to 1700 microns, from 100 microns to 1600 microns, from 100 to 1500 microns, from 100 microns to 1400 microns, from 100 microns, to 1300 microns, from 100 microns to 1200 microns, from 100 microns to 1100 microns, from 100 microns to 1000 microns, from 100 microns to 900 microns, from 100 microns to 800 microns, from 100 microns to 700 microns, from 100 microns to 600 microns, from 100 microns to 500 microns, from 100 microns to 400 microns, from 100 microns to 300 microns, or from 100 microns to 200 microns.

In some embodiments the ER (10/20) of the composite may be less than 500 mΩ-cm², less than 450 mΩ-cm², less than 400 mΩ-cm², less than 350 mΩ-cm², less than 300 mΩ-cm², less than 250 mΩ-cm², 200 mΩ-cm², less than 190 mΩ-cm², less than 180 mΩ-cm², less than 170 mΩ-cm², less than 160 mΩ-cm², less than 150 mΩ-cm², less than 140 mΩ-cm², less than 130 mΩ-cm², less than 120 mΩ-cm², or less than 110 mΩ-cm². In particularly preferred embodiments, the ER (10/20) of the composite is less than 100 mΩ-cm², less than 90 mΩ-cm², or less than 80 mΩ-cm².

The membranes of the composite may be attached to one another or not attached. Some modes of attachment may include gluing, laminating, co-extruding of the membranes together, mechanical sealing, heat sealing, pressure sealing, or combinations thereof. In some embodiments, the membranes may only be attached at or near the edges.

Composite Comprising Membranes with Different Average Pore Size

In some embodiments, the composite may comprise: 1) a membrane as described hereinabove, and 2) at least one other hydrophilic porous flat-sheet membrane that has a larger average pore size. In some embodiments, the pores may be at least 0.01 microns larger, at least 0.02 microns larger, at least 0.03 microns larger, at least 0.04 microns larger, at least 0.05 microns larger, at least 0.06 microns larger, at least 0.07 microns larger, at least 0.08 microns larger, at least 0.09 microns larger, at least 0.1 microns larger, at least 0.2 microns larger, at least 0.3 microns larger, at least 0.4 microns larger, or at least 0.5 microns larger. In some embodiments, the least one other hydrophilic porous flat-sheet membrane that has a larger average pore size may be thinner than the other membrane. In some embodiments, it may be 10% thinner, 20% thinner, 30% thinner, 40% thinner, 50% thinner, 60% thinner, 70% thinner 80% thinner or 90% thinner.

In some embodiments, the membrane having the smaller average pore size may be tortuous. For example, a tortuosity of the membrane may be greater than 1.1, greater than 1.2, greater than 1.3, greater than 1.4, greater than 1.5, greater than 1.6, greater than 1.7, greater than 1.8, greater than 1.9, or greater than 2.0. Gurley, a possible indicator of tortuosity, may be greater than 200 seconds, greater than 300 seconds, greater than 400 seconds, greater than 500 seconds, greater than 600 seconds, greater than 700 seconds, greater than 800 seconds, greater than 900 seconds, or greater than 1,000 seconds.

In some embodiments, the hydrophilic porous flat-sheet membrane that has a larger average pore size may also be a membrane as described herein above. In such embodiments, one of the membranes may have been stretched, calendered, or stretched and calendered to create the desired pore sizes.

In other embodiments, the hydrophilic porous flat-sheet membrane that has a larger average pore size may be different than the membranes described hereinabove. For example, the hydrophilic porous flat-sheet membrane that has a larger average pore size may be a fibrous membrane formed from polymeric fibers, glass fibers, or combinations thereof.

Composite Comprising a Membrane with Surfactant

In some embodiments, at least one of the hydrophilic porous flat-sheet membranes of the composite may comprise a surfactant therein. For example, the hydrophilic porous flat-sheet membrane with the surfactant therein or thereon may be as described as herein above.

Composite Comprising a Membrane with Rubber or Latex

In some embodiments, at least one of the hydrophilic porous flat-sheet membranes of the composite may comprise natural or synthetic rubber, natural or synthetic rubber derivatives, natural or synthetic latex, natural or synthetic latex derivatives, or combinations of the foregoing. For example, the hydrophilic porous flat-sheet membrane comprising natural or synthetic rubber, natural or synthetic rubber derivatives, natural or synthetic latex, or natural or synthetic latex derivatives may be as described hereinabove.

Composite Comprising a Membrane with Oil

In some embodiments, at least one of the hydrophilic porous flat-sheet membranes of the composite is a hydrophilic porous flat-sheet filled polyolefin membrane as described herein above that comprises, consists of, or consists essentially of polyolefin, filler, and oil, wherein an amount of oil is from 0.5% to 20%, 0.5% to 15%, 0.5% to 10%, 0.5% to 5%, 0.5% to 2%, or 0.5% to 1%.

Composite Comprising a Membrane with an ER (10/20) of Less than 250 mΩ-Cm²

In some embodiments, at least one of the hydrophilic porous flat-sheet membranes of the composites has an ER (10/20) of less than 250 mΩ-cm², less than 225 mΩ-cm², less than 200 mΩ-cm², less than 175 mΩ-cm², less than 150 mΩ-cm², less than 125 mΩ-cm², less than 100 mΩ-cm², less than 75 mΩ-cm², or less than 50 mΩ-cm².

Composite Comprising a Membrane with High Silica: Polymer Ratio

In some embodiments, the composite may comprise, consist of, or consist essentially of a membrane as described herein above and at least one hydrophilic porous flat-sheet membrane that is a polyolefin-filled membrane having a higher silica: polymer ratio. The ratio may be 2.7:1 or higher, 2.8:1 or higher, 2.9:1 or higher, 3:1 or higher, 3.1:1 or higher, 3.2:1 or higher, 3.3:1 or higher, 3.4:1 or higher, 3.5:1 or higher, 3.6:1 or higher, 3.7:1 or higher, 3.8:1 or higher, 3.9:1 or higher, 4.0:1 or higher, or as high as 5:1. In such embodiments, the silica may interact with the electrolyte ions, impeding their movement across the membrane.

Composite Comprising a Membrane with a Conductive Material

In some embodiments, the composite may comprise, consist of, or consist essentially of a membrane as described herein above and at least one hydrophilic porous flat-sheet membrane that comprises a conductive material therein or thereon. In some preferred embodiments, the conductive material may comprise, consist of, or consist essentially of carbon. For example, the carbon may be one of conductive carbon, graphite, artificial graphite, activated carbon, acetylene black, carbon black, high surface area carbon black, graphene, high surface area graphene, ketjen black, carbon fibers, carbon filaments, carbon nanotubes, polymer alloys, intrinsically conducting polymers (ICPs), or any combinations thereof.

In some embodiments, the composite may comprise the following in that order: a hydrophilic porous flat-sheet membrane that comprises a conductive material therein or thereon; a membrane as described herein above; and another hydrophilic porous flat-sheet membrane that comprises a conductive material therein or thereon. Use of such a composite may obviate the use of felt (e.g., carbon felt) that is typical in a flow battery.

### Asymmetric Membrane

An asymmetric membrane as described herein may comprise a membrane as described herein above, wherein one side or surface of the membrane is different from the other side or surface.

For example, the asymmetric membrane may comprise a membrane as described hereinabove, wherein one side or surface of the membrane may have a smaller average pore size than the other side or surface. One way this may be achieved is by calendering the membrane, by applying a different temperature to each side or using asymmetrical tooling.

In other embodiments, one side or surface of the membrane may have a surfactant thereon or therein, while the other side or surface of the membrane has no surfactant therein or thereon, or has a different surfactant therein or thereon.

In some embodiments, one side or surface of the membrane may comprise a conductive material therein or thereon, while the other side or surface has no conductive material therein or thereon or comprises a different conductive material therein or thereon.

In some embodiments, the membrane may comprise added natural or synthetic rubber, natural or synthetic rubber derivatives, natural or synthetic latex, natural or synthetic latex derivatives, or combinations of the foregoing. In such embodiments, one side of the membrane may be exposed to light, heat, or light and heat to initiate a cross-linking reaction with these additives on one side of the membrane resulting in an asymmetric structure.

In some embodiments, the membrane may have a performance-enhancing coating on one side thereof.

### EXAMPLES

First, hydrophilic porous polyolefin filled membranes as described in Table 1 herein are manufactured. These membranes comprise polyethylene, silica filler, and oil.

TABLE 1

| Characteristic | Unit | MEM 1 | MEM 2 | MEM 3 | MEM 4 | MEM 5 |
|---|---|---|---|---|---|---|
| thickness | micron | 175 | 250 | 450 | 600 | 900 |
| Tensile - MD | N/mm2 | 16.67 | 12.03 | 8.30 | 10.02 | 8.01 |
| Elongation - | % | 184.91 | 241.38 | 98.90 | 326.88 | 273.89 |
| MD | | | | | | |
| Tensile - CMD | N/mm2 | 6.16 | 5.28 | 7.07 | 7.38 | 5.43 |
| Elongation - | % | 229.53 | 369.22 | 340.24 | 384.88 | 280.91 |
| CMD | | | | | | |
| Total Oil | % | 1-20% | 1-20% | 1-20% | 1-20% | 1-20% |
| Silica:Polymer | | 2:1 to | 2:1 to | 2:1 to | 2:1 to | 2:1 to |
| ratio | | 4:1 | 4:1 | 4:1 | 4:1 | 4:1 |
| Porosity | % | 60.37 | 58.68 | 56.53 | 51.32 | 66.78 |
| ER (10/20) | mohm- | 39.35 | 46.7 | 221.7 | 272.8 | 157.2 |
| | cm2 | | | | | |
| grammage | gsm | 115.33 | 152.89 | 252.75 | 373.96 | 447.57 |
| anionic | g/m2 | 0.01 to | 0.01 to | 0.01 to | 0.01 to | 0.01 to |
| surfactant | | 5 | 5 | 5 | 5 | 5 |
| non-ionic | g/m2 | 0.1 to | | | 0.1 to | |
| surfactant | | 7 | | | 7 | |
| Gurley (50 cc) | seconds | 358 | 742 | 1028 | 1960 | 2061 |
| PORE SIZE | MI- | 0.14 | 0.07 | 0.07 | 0.06 | 0.06 |
| MAXIMUM | CRON | | | | | |
| PORE SIZE | MI- | 0.08 | 0.05 | 0.04 | 0.04 | 0.03 |
| MEAN | CRON | | | | | |
| PORE SIZE | MI- | 0.002 | 0.03 | 0.03 | 0.02 | 0.02 |
| MINIMUM | CRON | | | | | |

Two or more of the membranes in Table 1 are combined to form the composite membranes described herein. For example, the following exemplary composites are formed.

Example Composite 1: MEM 1 (larger pore size) and MEM 2. It is believed that by combining a larger average pore size and a smaller average pore size membrane together, a balance between maintaining lower ER and reducing or impeding cross-contamination of the electrolytes may be achieved. Smaller pore size may be achieved by calendering.

Example Composite 2: MEM 1 (larger pore size) and MEM 3. By having the membrane with smaller pores (MEM 3) be thicker, cross-contamination of the electrolytes may be better achieved. Especially, when a tortuous membrane is used, cross-contamination will be slowed and reduced.

Example Composite 3: MEM 1 (larger pore size) and MEM 4. By having the membrane with smaller pores (MEM 4) be thicker, cross-contamination of the electrolytes may be better achieved. Especially, when a tortuous membrane is used, cross-contamination will be slowed and reduced.

Example Composite 4: MEM 1 (larger pore size) and MEM 5. By having the membrane with smaller pores (MEM 5) be thicker, cross-contamination of the electrolytes may be better achieved. Especially, when a tortuous membrane is used, cross-contamination will be slowed and reduced.

Example Composite 5: MEM 1 and fibrous membrane having an average pore size of 0.1 to 5 microns (larger pore size). It is believed that by combining a larger average pore size and a smaller average pore size membrane together, a balance between maintaining lower ER and hindering, reducing, or impeding cross-contamination of the electrolytes may be achieved. By having the membrane with smaller pores (MEM 2) be thicker, cross-contamination of the electrolytes may be better achieved. Especially, when a tortuous membrane is used, cross-contamination will be slowed and reduced.

Example Composite 6: MEM 2 and fibrous membrane having an average pore size of 0.1 to 5 microns (larger pore size). By having the membrane with smaller pores (MEM 2) be thicker, cross-contamination of the electrolytes may be better achieved. Especially, when a tortuous membrane is used, cross-contamination will be slowed and reduced.

Example Composite 7: MEM 3 and fibrous membrane having an average pore size of 0.1 to 5 microns (larger pore size). By having the membrane with smaller pores (MEM 4) be thicker, cross-contamination of the electrolytes may be better achieved. Especially, when a tortuous membrane is used, cross-contamination will be slowed and reduced.

Example Composite 8: MEM 4 and fibrous membrane having an average pore size of 0.1 to 5 microns (larger pore size). By having the membrane with smaller pores (MEM 4) be thicker, cross-contamination of the electrolytes may be better achieved. Especially, when a tortuous membrane is used, cross-contamination will be slowed and reduced.

Example Composite 9: MEM 5 and fibrous membrane having an average pore size of 0.1 to 5 microns (larger pore size). By having the membrane with smaller pores (MEM 5) be thicker, cross-contamination of the electrolytes may be better achieved. Especially, when a tortuous membrane is used, cross-contamination will be slowed and reduced.

Example composite 10: MEM 5 (low oil and higher silica: polymer ratio) with MEM 4.

Example composite 11: MEM 5 (low oil and higher silica: polymer ratio) with MEM 3.

Example composite 12: MEM 5 (low oil and higher silica: polymer ratio) with MEM 2.

Example composite 13: MEM 5 (low oil and higher silica: polymer ratio) with MEM 1.

Example Composite 14: MEM 1 (with non-ionic surfactant) and MEM2. It is hypothesized that the nonionic surfactant may react with electrolyte ions reducing or impeding cross-contamination of the electrolytes.

Example Composite 15: MEM 1 (with non-ionic surfactant) and MEM3.

Example Composite 16: MEM 1 (with non-ionic surfactant) and MEM4.

Example Composite 17: MEM 1 (with non-ionic surfactant) and MEM5.

Example Composite 18: like Example Composite 1 except MEM 1 (larger pore size) is ribbed.

Example Composite 19: like Example 1 except MEM 2 is ribbed.

Each of the membranes includes tortuous pores. It is believed that by using a thicker membrane with smaller pores together with a thinner membrane with larger pores, cross-contamination of electrolytes can be avoided, while still allowing transport of charge-carrying electrolyte ions, maintaining low electrical resistance (ER), and other beneficial properties. Providing a thicker/smaller pore membrane with lower oil content (see Example 4, which includes MEM 5) is also believed to be beneficial. Though increasing membrane thickness often results in increased ER, by using a low oil content (i.e., less than 5%, less than 2%, or less than 1%) ER is reduced compared to a thicker membrane that contains more oil.

Example Composite 20: MEM 1 with a carbon-containing hydrophilic porous flat-sheet membrane on one both sides thereof. Providing carbon-containing hydrophilic porous flat-sheet membrane may obviate the use of felt (e.g., carbon felt) typically used in flow batteries.

Example Composite 21: MEM 2 with a carbon-containing hydrophilic porous flat-sheet membrane on one or both sides thereof.

Example Composite 22: MEM 3 with a carbon-containing hydrophilic porous flat-sheet membrane on one or both sides thereof.

Example Composite 23: MEM 4 with a carbon-containing hydrophilic porous flat-sheet membrane on one or both sides thereof.

Example Composite 24: MEM 5 with a carbon-containing hydrophilic porous flat-sheet membrane on one or both sides thereof.

10/20 Electrical Resistance is measured according to BCIS-03B, January 2018, Section 3, 3.0 ELECTRICAL RESISTIVITY USING THE PALICO SYSTEM Elongation and Tensile is measured by BCIS-03B January 2018, Section 4, Elongation and Tensile Strength.

Porosity is measured according to BCIS-03B, January 2018, section 6, Porosity (volume) and Moisture Content, utilizing a surfactant water instead of distilled water to wet completely and boil the membranes in.

Oil Content is measured according to BCIS-03B, January 2018, section 35, Total and Backweb Oil Content for Polyethylene based Separators.

Pore Size is measured using a porometer that follows ASTM F316-03 (2011). Gurley is measured using the genuine Gurley densometer with a 50 cc volume of air.

In accordance with at least certain embodiments, objects or aspects of the invention or this disclosure, there are provided or contemplated single or multiple layered membranes for a flow battery having low oil content, a surfactant coating, and/or post extraction calendering, a composite membrane for a flow battery, having a hydrophilic porous flat-sheet filled polyolefin membrane and at least one other hydrophilic porous flat-sheet membrane, an asymmetric hydrophilic porous flat-sheet membrane for a flow battery, an asymmetric hydrophilic porous filled polyolefin flat-sheet membrane for a flow battery, a post-extraction calendered hydrophilic porous filled polyolefin flat-sheet membrane for a flow battery, and combinations thereof.

In accordance with at least certain embodiments, objects or aspects of the invention or this disclosure, there are provided or contemplated a composite membrane for a flow battery, having: a hydrophilic porous flat-sheet filled polyolefin membrane; and at least one other hydrophilic porous flat-sheet membrane. In other embodiments, an asymmetric hydrophilic porous flat-sheet membrane is disclosed. The asymmetric hydrophilic porous flat-sheet membrane may be an asymmetric hydrophilic porous filled polyolefin flat-sheet membrane.

1. A composite membrane for a flow battery, comprising:
a hydrophilic porous flat-sheet filled polyolefin membrane; and
at least one other hydrophilic porous flat-sheet membrane.

2. The composite membrane of claim 1, wherein the at least one other hydrophilic porous flat-sheet membrane is a porous flat-sheet filled polyolefin membrane;
wherein one hydrophilic porous flat-sheet membrane has a smaller average pore size than the other one;
wherein one hydrophilic porous flat-sheet membrane has a smaller average pore size than the other one,
wherein the smaller average pore size is from 0.001 to 1 micron;
wherein the smaller average pore size is from 0.001 to 0.05 micron; and
wherein the membrane having a smaller average pore size is also thicker than the other membrane;
wherein the hydrophilic porous flat-sheet membrane having smaller average pore size is a calendered, a stretched, or a calendered and stretched porous flat-sheet membrane;
wherein at least one hydrophilic porous flat-sheet membrane comprises a surfactant therein or thereon;
wherein the surfactant comprises one or more of an anionic surfactant a non-ionic surfactant, an amphoteric surfactant, or combinations thereof;
wherein at least one hydrophilic porous flat-sheet membrane comprises, therein or thereon, rubber, rubber-derivatives, latex, latex-derivatives, or combinations thereof;
wherein the hydrophilic porous flat-sheet filled polyolefin membrane comprises polyolefin, filler, and oil, wherein an amount of oil is from 0.5% to 20%, 0.5% to 15% 0.5% to 10%, 0.5% to 5%, 0.5% to 2%, or 0.5% to 1%;
wherein at least one hydrophilic porous flat-sheet membrane has an ER (10/20) of less than 250 mΩ-cm², less than 200 mΩ-cm² less than 150 mΩ-cm² less than 100 mΩ-cm², or less than 50 mΩ-cm²;
wherein the composite has a thickness of 100 microns to 1,800 microns;
wherein at least one hydrophilic porous flat-sheet membrane comprises a coating that comprises a conductive material, wherein the coating is on an outward facing surface of the membrane; or
wherein the conductive material comprises carbon.

3.-22. (canceled)

23. An asymmetrical hydrophilic porous flat-sheet membrane for a flow battery.

24. The asymmetrical hydrophilic porous flat-sheet membrane of claim 23, wherein the membrane is a hydrophilic porous flat-sheet polyolefin filled membrane;
wherein the average pore size on one side of the membrane is smaller than the average pore size on the other side:
wherein the smaller average pore size is from 0.001 to 1 micron:
wherein the smaller average pore size is from 0.001 to 0.1 microns;
wherein the smaller average pore size is from 0.001 to 0.05 microns;
wherein the smaller average pore size is from 0.001 to 0.005 microns:
wherein the membrane is calendered;
wherein the membrane is coated on one side and annealed on the other side;
rein a coating is provided on one side of the membrane, and a different coating is provided on the other side:
wherein one coating is a surfactant coating;
wherein the surfactant comprises a nonionic surfactant, an anionic surfactant, an amphoteric surfactant, or combinations thereof;
wherein the surfactant comprises a non-ionic surfactant and the membrane comprises oil, latex, latex derivatives, rubber, rubber derivatives, or combinations thereof;
wherein the membrane comprises latex, latex derivatives, rubber, rubber derivatives, or combinations thereof, and one side of the membrane has been cross-linked;
wherein the membrane comprises a coating that comprises a conductive material on at least one side thereof;
wherein the conductive material comprises carbon;
wherein the membrane comprises a coating that comprises a conductive material on at least one side thereof; or
wherein the conductive material comprises carbon.

25.-43. (canceled)

44. A post extraction calendered hydrophilic porous flat-sheet filled polyolefin membrane adapted for use in a flow battery comprises polyolefin, filler, and oil, wherein an amount of oil is from 0.5% to 20%, 0.5% to 15%, 0.5% to 10%, 0.5% to 5%, 0.5% to 2%, or 0.5% to 1%.

45. The post extraction calendered hydrophilic porous flat-sheet filled polyolefin membrane of claim 44, wherein a surfactant coating is provided on at least one side of the membrane.

46. A post extraction calendered hydrophilic porous flat-sheet filled polyolefin membrane adapted for use in a flow battery comprises polyolefin, filler, and oil, wherein a surfactant coating is provided on at least one side of the membrane.

47. The post extraction calendered hydrophilic porous flat-sheet filled polyolefin membrane of claim 46, wherein an amount of oil is from 0.5% to 20%, 0.5% to 15%, 0.5% to 10%, 0.5% to 5%, 0.5% to 2%, or 0.5% to 1%, and wherein a surfactant coating is provided on at least one side of the membrane.

48. (canceled)

49. (canceled)

50. (canceled)

51. A composite membrane for a flow battery, comprising:
a hydrophilic porous filled polyolefin membrane; and
at least one other hydrophilic porous membrane, wherein at least one of the hydrophilic porous filled polyolefin membranes comprises mini-ribs or mini-protrusions on at least one side thereof.

52. An asymmetrical hydrophilic porous flat-sheet membrane for a flow battery, comprising mini-ribs or mini-protrusions on at least one side thereof.

53. A composite membrane for a flow battery, comprising:
a hydrophilic porous flat-sheet filled thermoplastic polymer membrane; and
at least one other hydrophilic porous flat-sheet membrane or mesh.

54. The composite membrane of claim 53, wherein the thermoplastic polymer is one or more selected from the group consisting of polyolefins, polyethylene terephthalate (PET), polyvinyl chloride (PVC), polyamide, polystyrene (PS), polycarbonate (PC), polyether ketone (PEK), polyetherether ketone (PEEK), and polytetrafluoroethylene (PTFE).

55. A membrane adapted for use in a flow battery, comprising:
a hydrophilic porous flat-sheet filled polyolefin membrane; and
at least one other hydrophilic porous flat-sheet membrane or mesh.

56. In a flow battery, the improvement comprising the membrane of claim 1.

57. In a reduction-oxidation (redox) flow battery, the improvement comprising the membrane of claim 1.
